(19) United States
(12) Patent Application Publication
(10) Pub. No.: US 2015/0278234 A1
(43) Pub. Date: Oct. 1, 2015

(54) INLINE WEB PREVIEWS WITH DYNAMIC ASPECT RATIOS

(71) Applicant: Microsoft Corporation, Redmond, WA (US)

(72) Inventors: Joseph Masterson, Maple Valley, WA (US); John Gibbon, Renton, WA (US); Eduardo Melo, Seattle, WA (US)

(73) Assignee: MICROSOFT CORPORATION, Redmond, WA (US)

(21) Appl. No.: 14/460,968

(22) Filed: Aug. 15, 2014

Related U.S. Application Data
(60) Provisional application No. 61/973,070, filed on Mar. 31, 2014.

(51) Int. Cl. G06F 17/30

(52) U.S. Cl. CPC G06F 17/3089

(57) ABSTRACT

A system for providing inline web previews with dynamic aspect ratios. The system includes an automatic information layout engine to dynamically render a preview of web content located at one or more uniform resource locators contained in a message. The web content previews may be tailored to the display configuration of the device showing the web preview. The system may select an appropriate layout for rendering the web content preview based on one or more properties, such as size, resolution, or aspect ratio, of the display each time the web preview is displayed. Web content previews may be dynamically generated or updated as messages are composed, received, or displayed allowing senders and recipients to see the web content preview in a suitable layout.

### RELATED APPLICATIONS

This application claims the benefit of U.S. Provisional Application No. 61/973,070, filed Mar. 31, 2014, the disclosure of which is hereby incorporated by reference in its entirety.

### BACKGROUND

Users frequently share uniform resource locators for web pages and other web entities via email to communicate relevant information with other users. At the most basic level, sharing of a uniform resource locator (URL) simply involves copying the URL from the address bar of a web browser and pasting it into the body of an email message. Some email servers and/or clients add value to the email message by adding a summary of the content on the web page at the URL. Both senders and recipients may use any of a number of different types of devices when generating and consuming email messages containing URLs and the summaries. These various devices may differ in display characteristics, such as resolution, physical size, and aspect ratio. As a result, it is difficult to present the summary in a suitable and consistent manner across all devices.

It is with respect to these and other considerations that the present invention has been made. Although relatively specific problems have been discussed, it should be understood that the aspects of the invention disclosed herein should not be limited to solving the specific problems identified in the background.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

The system for providing inline web previews with dynamic aspect ratios includes an automatic information layout engine to dynamically render a preview of web content located at one or more uniform resource locators contained in a message. The system includes an automatic information layout engine. The automatic information layout engine process messages containing a uniform resource locator (URL) pointing to web-based content served by a web server and obtains a summary of the web-based content. The summarized content may include information such as, but not limited to, the title, a description (e.g., a snippet), and a dominant image associated with the web-based content. The automatic information layout engine uses the summarized content to generate a web content preview for the URL. The web content preview is inserted into the message containing the URL. The web content preview is arranged using a suitable web preview layout based on the display configuration information received from the client device. The system may select an appropriate layout for rendering the web content preview based on one or more properties, such as size, resolution, or aspect ratio, of the display each time the web preview is displayed. Web content previews may be dynamically generated or updated as messages are composed, received, or displayed allowing senders and recipients to see the web content preview in a suitable layout.

The method for providing web previews with dynamic aspect ratios performed by the system determines that the message contains a URL, obtains a summary of the content for the web resource/entity located at the URL, and collects display configuration information about the device or the user interface displaying the message containing the URL. The display configuration information may include, but is not limited to, the type of device, the physical size of the display, the resolution of the display, and the aspect ratio of the display. The information collected may also include information about the amount of the display allotted to display the message (e.g., the message window or other user interface component). The display configuration information is used to automatically determine the appropriate layout for displaying the web content preview on the client device. The summarized content is arranged in the selected device appropriate layout to form the web content preview, stored for future retrieval, and associated with the URL and/or the message containing the URL. The web content preview is inserted into the message in an appropriate location. When a message containing the web content preview is displayed, the summarized content may be retrieved and arranged in a device-appropriate layout to update the web content preview for the particular device displaying the message.

### BRIEF DESCRIPTION OF THE DRAWINGS

Further features, aspects, and advantages of the present disclosure will become better understood by reference to the following figures, wherein elements are not to scale so as to more clearly show the details and wherein like reference numbers indicate like elements throughout the several views:

FIG. 1 is a system diagram illustrating aspects of a system for providing web previews with dynamic aspect ratios;

FIG. 2A illustrates aspects of a web content preview presented in a horizontal layout on a client device;

FIG. 2B illustrates aspects of a web content preview presented in a vertical layout on a client device;

FIG. 3 is a high-level flowchart showing aspects of the method for providing web previews with dynamic aspect ratios performed by the system;

FIG. 4 is a block diagram of an architecture for a computing device with which aspects of the invention may be practiced;

FIG. 5A illustrates a mobile computing device with which aspects of the invention may be practiced;

FIG. 5B is a simplified block diagram of an architecture for a mobile computing device with which aspects of the invention may be practiced; and

FIG. 6 is a simplified block diagram of a distributed computing system for practicing aspects of the invention.

### DETAILED DESCRIPTION

Various aspects of the invention are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope of the embodiments to those skilled in the art. Embodiments may be practiced as methods, systems, or devices. Accordingly, embodiments may take the form of a hardware implementation, an entirely software implementation or an implementation combining software and hardware aspects. The following detailed description is, therefore, not to be taken in a limiting sense.

Aspects of a system for providing inline web previews with dynamic aspect ratios are described herein and illustrated in the accompanying figures. The system includes an automatic information layout engine to dynamically render a preview of web content located at one or more uniform resource locators contained in a message. The web content previews may be tailored to the display configuration of the device showing the web preview. The system may select an appropriate layout for rendering the web content preview based on one or more properties, such as size, resolution, or aspect ratio, of the display each time the web preview is displayed. Web content previews may be dynamically generated or updated as messages are composed, received, or displayed allowing senders and recipients to see the web content preview in a suitable layout.

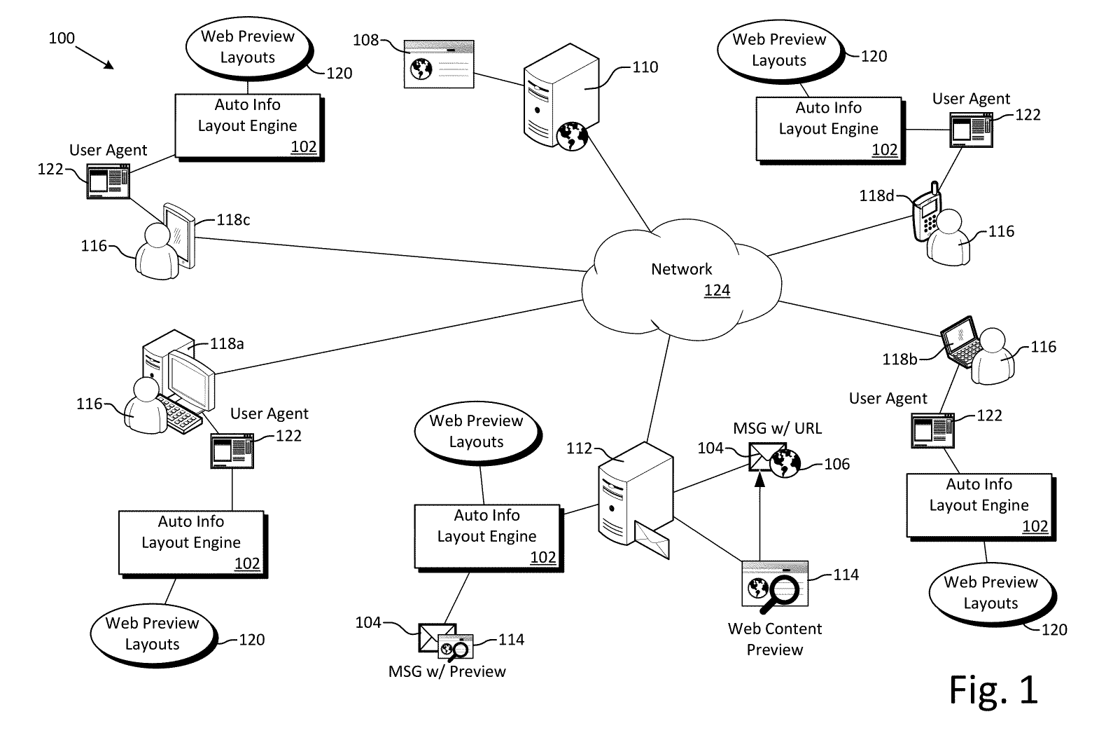

FIG. 1 is a system diagram illustrating aspects of a system for providing web previews with dynamic aspect ratios. The system 100 includes an automatic information layout engine 102. The automatic information layout engine 102 process messages 104 such as, but not limited to, email messages or instant messages, containing a uniform resource locator (URL) 106 pointing to web-based content 108 served by a web server 110. The automatic information layout engine 102 may run on a communication server 112, such as, but not limited to, an email server, and process the messages 104 sent by or received at the communication server 112. Likewise, the automatic information layout engine 102 may run on a separate server in communication with the communication server.

When the system detects that a message 104 contains one or more URLs, the automatic information layout engine 102 obtains a summary of the web-based content 108. The summarized content may include information such as, but not limited to, the title, a description (e.g., a snippet), and a dominant image associated with the web-based content 108. Summarized content may be obtained from data collected by a web search engine. The automatic information layout engine 102 uses the summarized content to generate a web content preview 114 for the URL. The web content preview 114 is inserted into the message 104 containing the URL by the automatic information layout engine 102. The web content preview 114 is generally constructed by arranging the summarized content in a container or layout object (e.g., an HTML frame, a table, or text box). The container/layout object allows the web content preview 114 to be treated as a single unit, which facilitates insertion into the message. The web content preview 114 may be inserted inline with the text in the body of the message. The web content preview 114 may be inserted near the position of the URL within the body of the message. For example, the web content preview 114 may be inserted immediately before or after the URL. Alternatively, the web content preview 114 may replace the URL in the body of the message.

Users 116 may generate and receive messages containing one or more URLs using a variety of client devices, including, but not limited to, desktop computers 118a, laptops 118b, tablets 118c, smartphones 118d, smart watches, and smart appliances. The client devices may be configured with displays having different physical sizes, resolutions, and/or aspect ratios and which may be utilized in different orientations (e.g., portrait or landscape). As a result, the same arrangement of the web content preview 114 may not be suitable for display on all client devices used to view the message.

The automatic information layout engine 102 arranges the web content preview 114 using a suitable web preview layout 120 based on the display configuration information received from the client device 118a-d. The web preview layouts 120 may be dynamically generated or stored as predefined layout definitions. The web preview layouts 120 may include at least one horizontal (i.e., landscape) layout for use when the aspect ratio of the display is greater than one (i.e., large aspect ratio) and at least one vertical (i.e., portrait) layout for use when the aspect ratio of the display is less than one (i.e., small aspect ratio). The resolution, physical size, and other properties of the display may be considered when arranging the web content preview 114. For example, larger and/or higher resolution displays may be capable of suitably displaying a web content preview 114 in a horizontal or vertical layout. Other layouts may be provided to accommodate a wide variety of specific display configuration scenarios.

When user 116 interacts with messages containing a web-based content URL 106 or a web page preview 114 from a client device 118a-d, the automatic information layout engine 102 collects display configuration information about client device 118a-d. Because the sender and the recipient of the message may access the applications from different client devices with different display capabilities, the automatic information layout engine 102 may collect display configuration information each time a request for the content message content is received. The automatic information layout engine 102 may collect information on periodic basis or only at the first request from a particular client device during a single session. In this manner, the system dynamically presents the same information in a device-appropriate web content preview to each user (e.g., the sender and all recipients) viewing the message based on the client device being used.

To provide a suitable viewing experience, the automatic information layout engine 102 requests display configuration information from the client device 118a-d showing the web content preview 114. Display configuration information may be requested by a number of techniques including, but not limited to, calls to an application programming interface (API) provided by the operating system on the client device, remote procedure calls (RPC) and other inter-process communications, structured query language (SQL) queries, electronic data interchange (EDI) communications, and requests using a general or specialized protocol suitable for obtaining about the client device 118a-d. The display configuration information usable by the system includes information that can be used directly to assess the current display configuration of the client device 118a-d (e.g., resolution, orientation, or aspect ratio). The system may also obtain information that indirectly allows the display capabilities of the client device 118a-d to be determined. For example, the system may receive a model number associated with the client device 118a-d that may be used to locate the corresponding display capabilities, which may be stored in a database, table, list, or other reference source. Such information may include extended information that is not normally utilized by the client device 118a-d, such as the physical size of the display.

The automatic information layout engine 102 may detect URLs within messages using client-side detection, server-side detection, or both. The initial detection of a URL within a message may occur in a user agent 122 (e.g., a messaging client) running on the client device. The user agent 122 provides a user interface that allows the user 116 to compose, edit, send, receive, and display messages. When a URL is detected, the user agent 122 may notify the automatic information layout engine 102 to initiate processing of the message to insert the web content preview 114. Client-side detection of URLs may be utilized during composition, editing, and viewing of the message to allow the system to respond to various events affecting the suitability of the presentation of the web content preview 114. For example, the client-side detection may allow the system to substantially contemporaneously detect that a URL has been added to a local copy of a message being composed before the communication server has access to the message content (i.e., before it has been saved). Client-side detection may allow the system to dynamically update the layout of the web content preview 114 in response to changes in display orientation/aspect ratio at the client device (e.g., physically rotating a smart phone or tablet, resizing the message window, or reconfiguring the graphics adapter settings) after initially rendering the web content preview 114 for a particular orientation.

Server-side detection may occur when a client device requests the content of a message from the communication server, including, but not limited to draft (i.e., unsent) messages, sent messages, and received messages. When a request for message content is received, the automatic information layout engine 102 may analyze the message to determine if it includes a web-based content URL 106 or a web page preview 114. If so, the automatic information layout engine 102 may interrogate the client device 118a-d to obtain display configuration information and insert an appropriate web page preview 114 before sending the message content to the client device.

The web server 110, the communication server 112, and the client devices 118a-d may be in communication via one or more networks 124, such as, but not limited to, the Internet, an intranet, a local area network, or a wide area network. The system 100 is operable with a wide variety of computing devices including, but not limited to, smartphones, tablets, laptops, and desktop computers using a wide variety of user interface and input types, such as, but not limited to, speech, typing, touch gestures, and menu navigation via, for example, text based interfaces, graphical user interfaces (GUIs), natural user interfaces (NUIs), spoken language interfaces (i.e., speech recognition systems).

The system 100 may operate as server-based solution, a client-based solution, a client/server based solution, or a distributed solution. Some or all of the functionality of the automatic information layout engine 102 may be embedded in the web content preview. For example, the web content preview may include scripts that are triggered when the web content preview is accessed that analyze the current display/window configuration and provides a custom layout of the information based thereon.

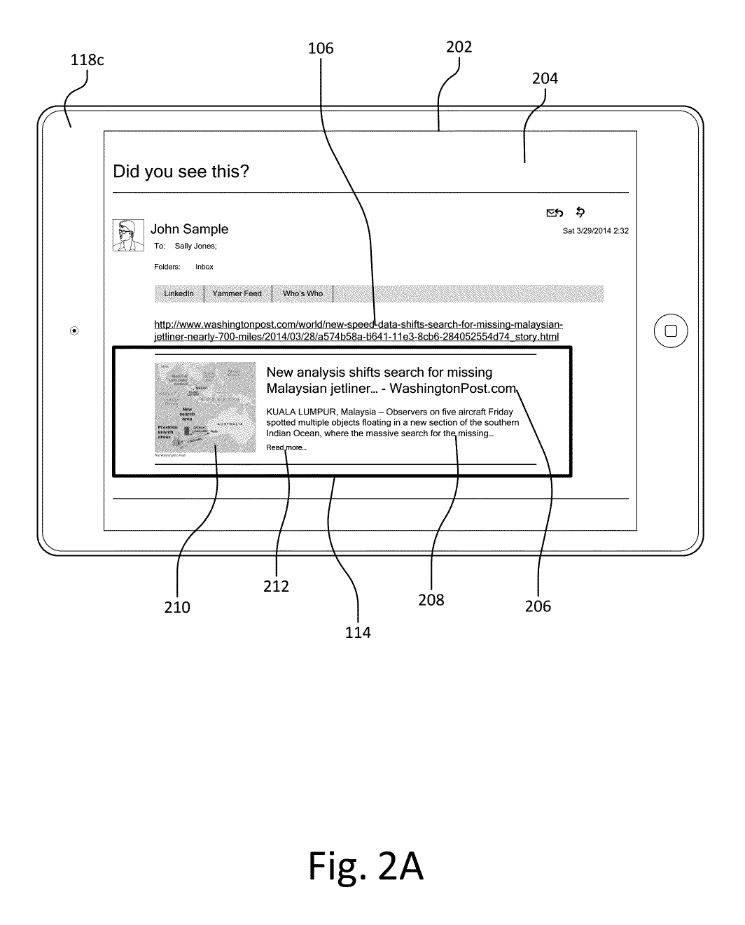

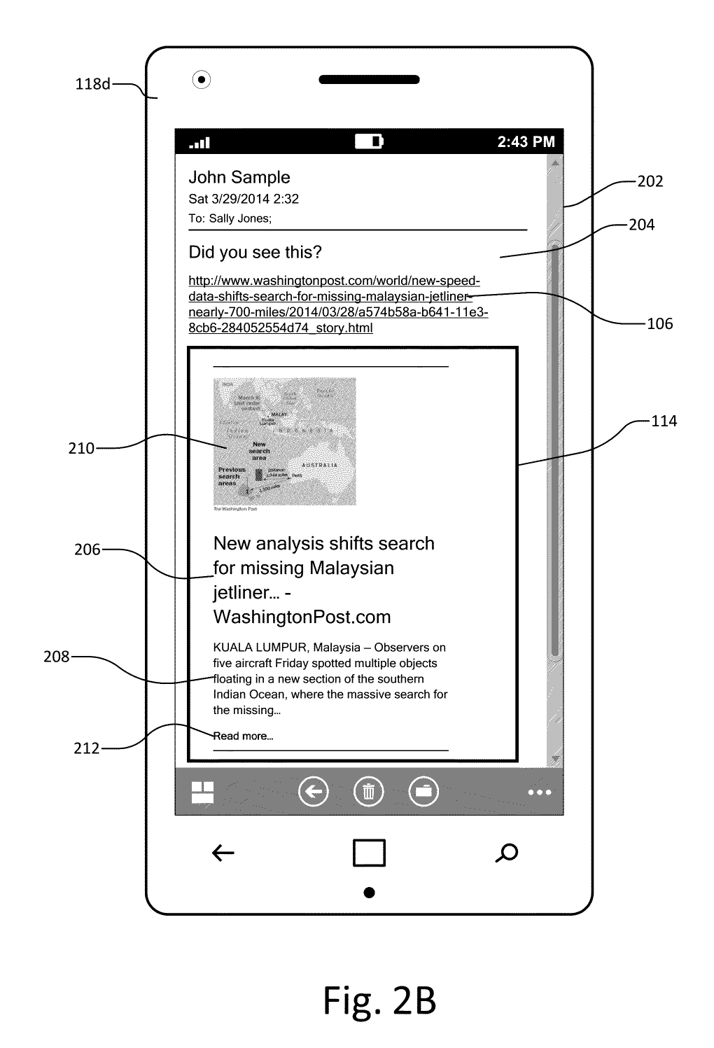

FIG. 2A illustrates aspects of a web content preview presented in a horizontal layout on a client device. In the illustrated embodiment, the client device is a tablet 118c with a 4:3 aspect ratio. The display 202 of the tablet 118c is currently configured as a landscape orientation display. The web-based content URL 106 and the web content preview 114 are presented in the body of an email message received by a user via the user interface 204 of an email application. The illustrated web content preview 114 includes the title 206, the description 208, and the dominant image 210 associated with the web-based content. In the horizontal layout, the title 206 and the description 208 are positioned to one side of the dominant image 210. In addition, the illustrated web content preview 114 includes a link 212 that may be activated by the user to access the web content (e.g., browse to a web page or play a web-based media file), which is also to one side of the dominant image 210. The components of the web content preview 114 may be contained within a horizontal container and inserted inline immediately following the web-based content URL 106. The container may include a border that serves to visually distinguish the web content preview 114 from the rest of the message content.

FIG. 2B illustrates aspects of a web content preview presented in a vertical layout on a client device. In the illustrated embodiment, the client device is a smartphone 118d with a 3:2 aspect ratio. Once again, both the web-based content URL 106 and the web content preview 114 are presented in the body of an email message received by a user via the user interface 204 of an email application. The information appearing in the web content preview 114 remains the same; however, in this instance, the layout has been dynamically updated to be appropriate for the smartphone 118d operating with the display 202 in a portrait orientation/small aspect ratio display configuration. The illustrated vertical web content preview 114 arranges the title 206, the description 208, and link 212 all below the dominant image 210.

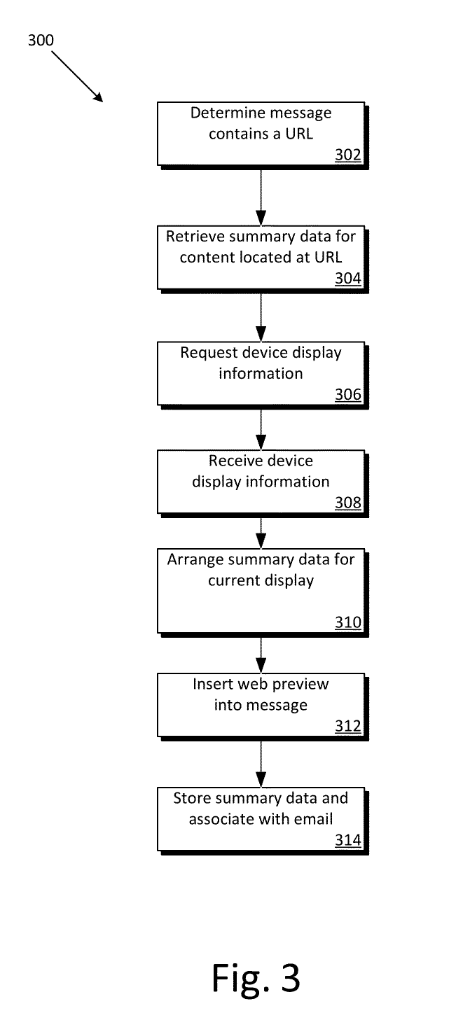

FIG. 3 is a high-level flowchart showing aspects of the method for providing web previews with dynamic aspect ratios performed by the system. The method 300 begins with a URL detection operation 302 in which the system determines that the message contains a URL. A URL may be detected by identifying sequences of characters in the body of the message. For example, a character sequence beginning with “http://” or “https://” or other recognized addressing scheme may be recognized as a URL. Similarly, a character sequence starting with containing a fully qualified domain name (e.g., “myhost.example.com”) or a resolvable partial domain name (e.g., example.com, which successfully resolves to www.example.com) may be recognized as a URL. In such cases, the fully qualified domain name may be reformatted as a proper URL. Further, a literal numeric Internet protocol address (e.g., an IPv4 or IPv6) address that resolves to a fully qualified domain name may be recognized as a URL. Recognition of fully qualified domain names as URLs may be limited to certain generic top level domains (TLDs) associated with the Internet, including, but not limited to, generic TLDs (e.g., .com, .edu, .org, or .gov), country code TLDs (e.g., .us, .uk, .cn, or .jp) and/or administered by the Internet Assigned Numbers Authority (IANA). The URL may link to web-based content. Detection of the URL may be automatic and result in automatic generation of a web content preview. Additionally, URL detection may occur when the user may manually identifies the URL and initiates generation of the web content preview.

A content collection operation 304 obtains a summary of the content for the web resource/entity located at the URL. The system may obtain the summarized content using any of a number of techniques, such as, but not limited to, by parsing the metadata and content of the web resource/entity or requesting summarized content of the web resource compiled by a web search engine. The summarized content may contain data such as, but not limited to, the title, a description or snippet of the content, and one or more dominant images associated with the web resource/entity.

An information collection operation 306 collects display configuration information about the device displaying the message containing the URL. The display configuration information may include, but is not limited to, the type of device, the physical size of the display, the resolution of the display, and the aspect ratio of the display. The information collected may also include information about the amount of the display allotted to display the message. For example, only a portion of the display may be used to display the message. Additional information may be collected including GPS location, network latency, and user movement may be used to further customize the web content preview or its presentation, such as, but not limited to, providing an audible summary of the information rendered using a text-to-speech engine for eyes-free operation when the user is moving or using a lower resolution for the dominant image if the client device is on a low bandwidth network.

A layout selection operation 308 uses the display configuration information to automatically determine the appropriate layout for displaying the web content preview on the client device. On devices with displays that are physically small, have low resolution, or have a constrained width (i.e., a small aspect ratio), the web content preview may be presented in a vertical layout. On devices with displays that are physically large, have high resolution, or have wider width (i.e., a large aspect ratio), the web content preview may be presented in a horizontal layout.

The appropriate layout may be selected based on the display configuration of the message window displaying the message. The aspect ratio of the message window may differ from the aspect ratio of the full display making a different layout more appropriate than the layout best suited when using the full display. The actual width or display of the message window may be the most significant factor in determining the appropriate layout. For example, a horizontal/landscape layout may not be suitable for displays or message windows with a width/horizontal resolution less than a selected minimum width/horizontal resolution.

A preview generation operation 310 arranges the summarized content in the selected device appropriate layout. A preview insertion operation 312 inserts the web content preview into the message in an appropriate location. For example, the web content preview may be inserted at the beginning or end of the message or inline with the text of the message. The inline web content preview may be inserted proximate to the corresponding URL, such as immediately before or after the URL. Inline web content previews facilitate adding a web content preview for each of multiple URLs contained in a single message.

A summary storage operation 314 stores the summarized content in an accessible storage location and associates the summarized content with the web preview, the URL, and/or the message containing the URL. For example, an identifier such as, but not limited to, a key value, a globally unique identifier (GUID), or other identifier may be used to link the stored summarized content with the web preview, the URL, or the message. The accessible storage location where the summarized content is stored may be data storage associated with the communication server or a computing device running the automatic information layout engine.

The summarized content may be retrieved from the accessible storage location using the identifier and arranged in a different device-appropriate layout when the associated message is displayed based on the display configuration information to provide a web content preview with a layout customized for the particular device displaying the message. In other words, the web preview is maintained as a set of components that may be dynamically rearranged into device-appropriate layouts at the time the message is displayed.

The subject matter of this application may be practiced in a variety of systems, devices, and other articles of manufacture or as methods. Embodiments may be implemented as hardware, software, computer readable media, or a combination thereof. The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which the invention may be practiced may be accomplished by, without limitation, keystroke entry, touch screen entry, voice or other audio entry, gesture entry where an associated computing device is equipped with detection (e.g., camera) functionality for capturing and interpreting user gestures for controlling the functionality of the computing device, and the like.

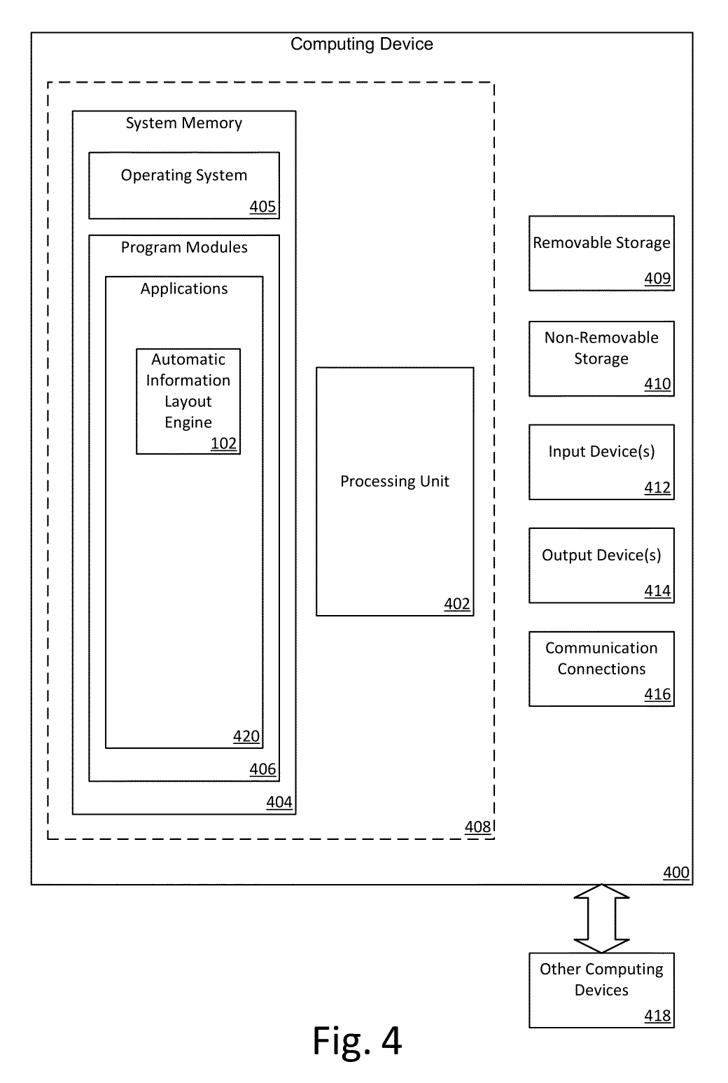

FIGS. 4 through 6 and the associated descriptions provide a discussion of a variety of operating environments for practicing aspects of the invention may be practiced. However, the devices and systems illustrated and discussed are for purposes of example and illustration and are not limiting of a vast number of computing device configurations that may be utilized for practicing aspects of the invention described herein.

FIG. 4 is a block diagram of an architecture for a computing device 400 with which aspects of the invention may be practiced. The computing device components described below may be suitable for embodying computing devices including, but not limited to, a personal computer, a tablet computer, a surface computer, and a smart phone, or any other computing device discussed herein. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 420 such as the automatic information layout engine 102. For example, the operating system 405 may be suitable for controlling the operation of the computing device 400. Furthermore, aspects of the invention may be practiced in conjunction with a graphics library, other operating systems, or any other application program and is not limited to any particular application or system. This basic configuration is illustrated by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated by a removable storage device 409 and a non-removable storage device 410.

As stated above, a number of program modules and data files may be stored in the system memory 404. While executing on the processing unit 402, the software applications 420 may perform processes including, but not limited to, one or more of the stages of the method 300. Other program modules that may be used in accordance with aspects of the invention may include electronic mail and contacts applications, word processing applications, spreadsheet applications, database applications, slide presentation applications, or computer-aided drawing application programs, etc.

Furthermore, aspects of the invention may be practiced in an electrical circuit comprising discrete electronic elements, packaged or integrated electronic chips containing logic gates, a circuit utilizing a microprocessor, or on a single chip containing electronic elements or microprocessors. For example, aspects of the invention may be practiced via a system-on-a-chip (SOC) where each or many of the illustrated components may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein with respect to the software applications 420 may be operated via application-specific logic integrated with other components of the computing device 400 on the single integrated circuit (chip). Aspects of the invention may also be practiced using other technologies capable of performing logical operations such as, for example, AND, OR, and NOT, including but not limited to mechanical, optical, fluidic, and quantum technologies. In addition, aspects of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all examples of computer storage media (i.e., memory storage). Computer storage media may include random access memory (RAM), read only memory (ROM), electrically erasable read-only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400.

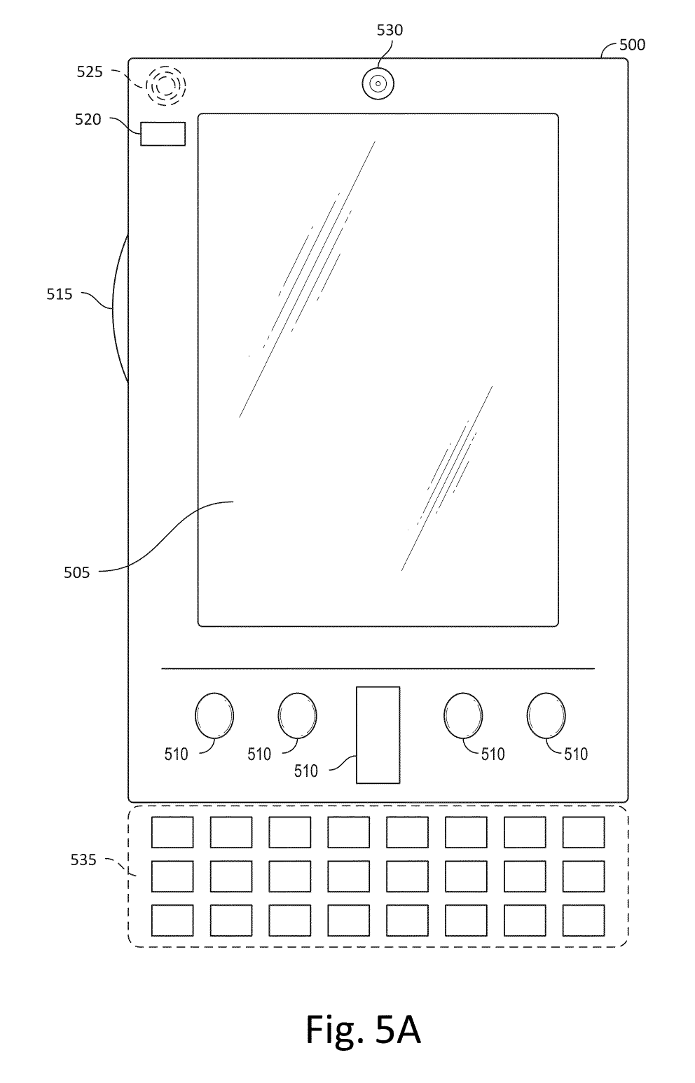

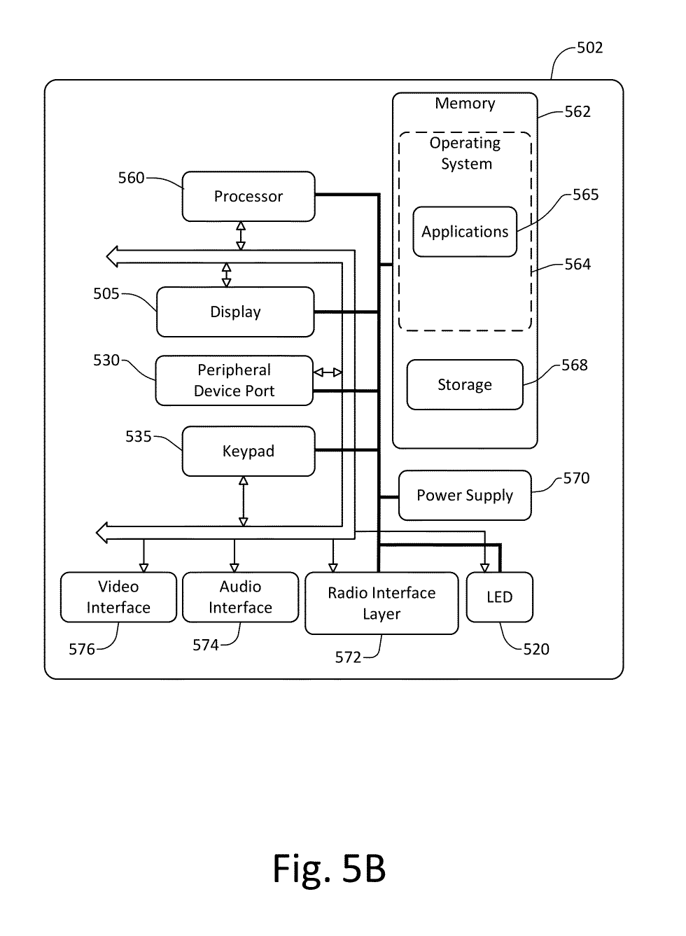

FIG. 5A illustrates a mobile computing device 500 with which aspects of the invention may be practiced. Examples of suitable mobile computing devices include, but are not limited to, a mobile telephone, a smart phone, a tablet computer, a surface computer, and a laptop computer. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. The mobile computing device 500 may incorporate more or less input elements. For example, the display 505 need not be a touch screen. The mobile computing device 500 may also include an optional keypad 535. Optional keypad 535 may be a physical keypad or a “soft” keypad generated on the touch screen display. The output elements include the display 505 for showing a graphical user interface, a visual indicator 520 (e.g., a light emitting diode), and/or an audio transducer 525 (e.g., a speaker). The mobile computing device 500 may incorporate a vibration transducer for providing the user with tactile feedback. The mobile computing device 500 may incorporate input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating an architecture for a mobile computing device with which aspects of the invention may be practiced. As an example, the mobile computing device 500 may be implemented in a system 502 such as a smart phone capable of running one or more applications (e.g., browsers, e-mail clients, notes, contact managers, messaging clients, games, and media clients/players).

One or more application programs 565 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 565 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500, including software applications 420 described herein.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the outside world via a communications carrier or service provider. Transmissions to and from the radio 572 are conducted under control of the operating system 564. In other words, communications received by the radio 572 may be disseminated to the application programs 565 via the operating system 564, and vice versa.

The visual indicator 520 may be used to provide visual notifications, and/or an audio interface 574 may be used for producing audible notifications via the audio transducer 525. As shown, the visual indicator 520 may be a light emitting diode (LED) and the audio transducer 525 may be a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. The microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

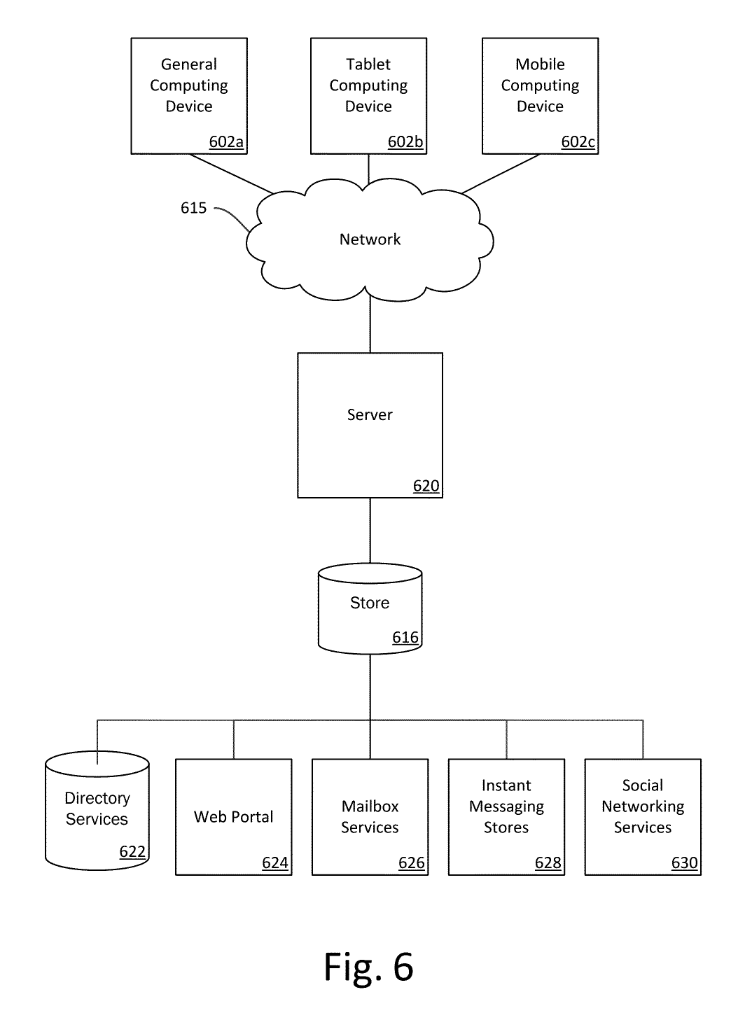

FIG. 6 is a simplified block diagram of a distributed computing system for practicing aspects of the invention. Content developed, interacted with, or edited in association with the software applications 420 may be stored in different communication channels or other storage types. For example, various documents may be stored using a directory service 622, a web portal 624, a mailbox service 626, an instant messaging store 628, or a social networking site 630. The software applications 420 may use any of these types of systems or the like for enabling data utilization, as described herein. A server 620 may provide the software applications 420 to clients. As one example, the server 620 may be a web server providing the software applications 420 over the web. The server 620 may provide the software applications 420 over the web to clients through a network 615. By way of example, the client computing device may be implemented as the computing device 400 and embodied in a personal computer 602a, a tablet computer 602b, and/or a mobile computing device (e.g., a smart phone) 602c. Any of these client devices may obtain content from the store 616.

The description and illustration of one or more embodiments provided in this application are intended to provide a complete thorough and complete disclosure the full scope of the subject matter to those skilled in the art and not intended to limit or restrict the scope of the invention as claimed in any way. The embodiments, examples, and details provided in this application are considered sufficient to convey possession and enable those skilled in the art to practice the best mode of claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, example, or detail provided in this application unless expressly stated herein. The various features and aspects of the invention (both structural and methodological), whether shown or described collectively or separately, may be selectively included or omitted to implement a particular set of features. Further, any or all of the functions and acts shown or described may be performed in any order or concurrently. Having been provided with the description and illustration of the present application, one skilled in the art may envision variations, modifications, and alternatives falling within the spirit of the broader aspects of the general inventive concept embodied in this application that do not depart from the broader scope of the claimed invention.

What is claimed is:

1. A method for providing inline web previews with dynamic aspect ratios, the method comprising the acts of:
receiving a request to display a message including a web preview associated with a uniform resource locator contained in the message;
collecting information about the display configuration of a computing device displaying a message;
selecting a layout for arranging summarized content associated with web preview based on the display configuration; and
displaying the summarized content in the message using the selected layout.

2. The method of claim 1 further comprising the act of determining that a message contains a uniform resource locator.

3. The method of claim 2 further comprising the act of summarizing web-based content of a web resource if the message contains a uniform resource locator.

4. The method of claim 3 wherein the act of summarizing web-based content of a web resource further comprises the act of parsing metadata and content from the web resource.

5. The method of claim 3 wherein the act of summarizing web-based content of a web resource further comprises the act of obtaining summarized content collected by a web search engine.

6. The method of claim 3 wherein the summarized content comprises a title associated with the web resource, a snippet from the web resource, and a dominant image from the web resource.

7. The method of claim 3 further comprising the act of inserting the web preview into the message containing the uniform resource locator.

8. The method of claim 3 further comprising the act of storing the summarized content in an accessible storage location for retrieval when displaying the summarized content in the message using the selected layout.

9. The method of claim 8 further comprising the act of linking the summarized content stored in the accessible storage location with the web preview, the message, or the uniform resource locator contained in the message.

10. The method of claim 8 further comprising the act of:
retrieving the linked summarized content from the accessible storage location for retrieval; and
positioning the summarized content in web preview according to the selected layout.

11. A system for providing inline web previews with dynamic aspect ratios, the system comprising:
a communication server operable to allow messages to be sent and received by users;
a computing device operable to present messages to users via a display; and
an automatic layout engine in communication with the communication server, the automatic layout engine operable to:
collect information about the display configuration of the computing device displaying a message including a web preview associated with a uniform resource locator contained in the message;
retrieve summarized content from the web resource corresponding to the uniform resource locator associated with the web preview; and
arrange the summarized content based on the display configuration.

12. The system of claim 11 wherein the automatic layout engine is further operable to detect a uniform resource locator contained in a message.

13. The system of claim 11 wherein the automatic layout engine is further operable to obtain summarized content of the web resource associated with the uniform resource locator in the message.

14. The system of claim 11 wherein the web preview is a container inserted into the message at a selected position, the container holding the summarized content in a selected arrangement.

15. The system of claim 11 further comprising a content summary store in communication with the automatic layout engine for storage of the summarized content.

16. The system of claim 11 wherein the display configuration includes a horizontal resolution of the display and a vertical resolution of the display.

17. The system of claim 16 wherein the summarized content is arranged in a horizontal layout when the horizontal resolution of the display is greater than the vertical resolution of the display and in a vertical layout when the horizontal resolution of the display is less than the vertical resolution of the display.

18. The system of claim 11 wherein the summarized content comprises a title associated with the web resource, a snippet from the web resource, and a dominant image from the web resource.

19. The system of claim 11 wherein the automatic layout engine runs on the communication server.

20. A computer readable medium containing computer executable instructions which, when executed by a computer, perform a method of providing inline web previews with dynamic aspect ratios, the method comprising:
detecting that a message contains a uniform resource locator;
when the message contains a uniform resource locator, obtaining summarized content of the web resource associated with the uniform resource locator;
collecting information about the display configuration of a computing device displaying the message;
inserting the summarized content into the message at a selected position; and
arranging the summarized content based on the display configuration of the computing device displaying the message;
whereby the summarized content is displayed as a web preview with a dynamic aspect ratio corresponding to the display configuration of the computing device displaying the message.
